(19) United States
(12) Patent Application Publication
(10) Pub. No.: US 2004/0072533 A1
(43) Pub. Date: Apr. 15, 2004

(54) Vent assembly with hinged grill unit for automobiles

(76) Inventor: Sung-Ho Cho, Kyeonggi-do (KR)

Correspondence Address: LEVINE & MANDELBAUM, 444 MADISON AVENUE, 35TH FLOOR, NEW YORK, NY, 10022, US

(21) Appl. No.: 10/467,559

(22) PCT Filed: Apr. 9, 2002
(86) PCT No.: PCT/KR02/00624

(30) Foreign Application Priority Data
Apr. 12, 2001 (KR) 2001/19617

(51) Int. Cl. B60H 1/34

(52) U.S. Cl. 454/155; 454/158; 454/316

(57) ABSTRACT

The object of this invention is to provide a vent assembly with a hinged grill unit for automobiles. In this vent assembly “A”, the grill unit (1) consists of a grillwork (11), and a grillwork holder (10) holding the grillwork (11) therein. Two hinge shafts (15) are provided at the holder for acting as a hinging means for hinging the grill unit to the housing. A drive member (3) is provided at a lower portion of the holder at a position vertically aligned with the hinge shafts (15), and engages with a reduction gear (32) of a motor (33) installed in the dashboard “B”. This grill unit (1) is rotatably set in the housing by the hinge shafts such that the grill unit is rotated around the shafts relative to the housing by a power of the motor transmitted to the drive member (3) through the reduction gear.

### TECHNICAL FIELD

The present invention relates, in general, to vent assemblies used for discharging hot and cold air into the passenger compartment of an automobile for accomplishing an air conditioning effect for the passenger compartment and, more particularly, to a vent assembly for automobiles, which has a hinged grill unit designed to be rotated relative to a housing by a one-touch action or a switching operation within a predetermined angular range, thereby allowing a user to selectively open the housing when it is desired to clean the grill unit and the interior of the housing. This vent assembly is also provided with a container for containing a desired material, such as an aromatic, with an air filter removably seated in a seating slot of the grill unit, and so the vent assembly blows fresh, clean and scented air into the passenger compartment.

### BACKGROUND ART

As well known to those skilled in the art, most automobiles are typically provided with air conditioning apparatuses, such as heaters or air conditioners, for discharging impure air from the passenger compartment to the atmosphere and feeding fresh hot or cool air into the compartment. Such fresh air fed from such an air conditioning apparatus is blown into the passenger compartment through the grillwork of a vent assembly installed at a dashboard.

The grillwork of a conventional vent assembly, acting as the final path guiding the fresh hot or cool air into the passenger compartment, comprises a plurality of grating bars which have a blade shape and are movably set in a grill frame fixedly installed in the venting channel of a dashboard. Therefore, when it is desired to change the air blowing direction of the grillwork, the grating bars are manually tilted upward, downward, leftward or rightward at a limited angle within the fixed grill frame.

In such a conventional vent assembly for automobiles, the air blowing direction of the grillwork is limitedly controlled by manually tilting the blade-shaped grating bars in the fixed grill frame to a desired direction within a limited angular range. It is thus almost impossible to clean the interior of the venting channel in back of the grill frame, and so a great quantity of dust is deposited in the venting channel as time goes by after the production of an automobile. Such deposited dust is blown into the passenger compartment along with fresh hot or cool air during an operation of an air conditioning apparatus, such as a heater or an air conditioner, thus being bad for passengers' health, particularly, for passengers' respiratory organs, and causing several diseases in said organs. Furthermore, the conventional vent assembly does not allow an installation of an air filter at a position around it, and so most passengers, including a driver while driving an automobile, inevitably breathe dust-laden air blown from the grillwork.

Another problem of the conventional vent assembly is caused by an absence of any means for holding air quality enhancing agents, such as aromatics, germicides, and/or deodorizers, in the assembly. Such agents are thus laid on the top wall of the dashboard or the rear shelf provided in back of the rear seats inside the passenger compartment, or attached to the front of the grillwork such that air laden with components of the agents circulates in the passenger compartment. However, such installation of the agents makes the interior of the passenger compartment messy, as well as interfering with the safe driving of a driver.

In an effort to overcome the problems experienced in the conventional vent assembly with the fixed grill frame, there was proposed and has been used a hot and cool air vent nozzle for automobiles in Korean Utility Model Registration No. 149,961 allowed to the inventor of this invention.

This vent nozzle, which comprises a grill frame with a grillwork, is installed in the dashboard of an automobile such that the grill frame is firmly installed in the venting channel of the dashboard, and the grillwork is rotatably set in the fixed grill frame. That is, two hinges are respectively formed at the upper and lower edges or both side edges of the grillwork, and so the grillwork is hinged in the fixed grill frame at the hinges. A user is thus allowed to open the interior of the venting channel by rotating the grillwork when it is desired to clean the interior of the venting channel, or to install an air quality enhancing agent in the interior of the channel. That is, when it is desired to open the interior of the venting channel, the user manually rotates the hinged grillwork in the fixed grill frame until a desired opening ratio of the channel is accomplished. After cleaning the interior of the venting channel or installing a desired agent in the channel, the grillwork is manually rotated in an inverse direction to close the venting channel.

However, a problem of the above vent nozzle resides in that it is necessary for a user to rotate the hinged grillwork relative to the grill frame fixed in the venting channel of the dashboard by manually pulling or pushing the grillwork when it is desired to open the venting channel. The grillwork opening or closing action is thus not smoothly performed. In addition, a user, wanting to open the venting channel, may carelessly touch the grillwork, which is excessively heated by hot air of a heater during the winter season, with his/her fingers. In such a case, the user is startled at the hot grillwork, and so the vent nozzle is inconvenient to users. Since the grillwork of the vent nozzle is designed to be manually rotated relative to the grill frame by a user, the hinges of the grillwork may be loaded with excessively high stress when the grillwork is rotated around the hinges by the user. In such a case, the hinges may be damaged or broken, and force the user to change the damaged or broken parts with new ones, thus excessively consuming time. This vent nozzle is thus inconvenient to the user, and forces the user to pay excessive money for purchasing the new parts. Another problem of the vent nozzle having such a manual-operated structure resides in that it undesirably devalues expensive luxury automobiles.

### DISCLOSURE OF THE INVENTION

Accordingly, the present invention has been made keeping in mind the above problems occurring in the prior art, and an object of the present invention is to provide a vent assembly for automobiles, which has a hinged grill unit connected to a motor at an end thereof, and rotated relative to a housing fixed in the venting channel of the dashboard by a power of the motor within a predetermined angular range, thereby allowing a user to selectively open the housing when it is desired to clean the grill unit and the interior of the housing, and which thus allows the user to effectively maintain the vent assembly in a clean state, and is not bad for passengers' health, particularly, for passengers' respiratory organs, and which upgrades the automobiles.

In order to accomplish the above object, the present invention provides a vent assembly for automobiles, comprising a housing installed in the dashboard of an automobile and a grill unit set in the housing, wherein the grill unit consists of a grillwork, and a grillwork holder holding the grillwork therein, with a drive member provided at the holder and operated in conjunction with a motor, the grill unit being hinged in the housing such that the grill unit is rotated relative to the housing within a predetermined angular range by a power of the motor.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is an exploded perspective view of a vent assembly for automobiles in accordance with the primary embodiment of the present invention;

FIG. 1b is a partially broken perspective view, showing an operation of the vent assembly according to the primary embodiment of this invention;

FIG. 2 is a side sectional view, showing the operation of the vent assembly according to the primary embodiment of this invention;

FIG. 3 is a perspective view of a vent assembly having two hinged grill units in accordance with the second embodiment of the present invention;

FIG. 4 is a perspective view of a vent assembly having a container part at the rear section of a grillwork holder in accordance with the third embodiment of the present invention;

FIG. 5 is an exploded perspective view of a vent assembly having two hinges respectively provided at the grillwork holder and the housing and jointed together by a pin in accordance with the fourth embodiment of the present invention;

FIG. 6 is a perspective view of a vent assembly having a seating slot for seating an air filter in accordance with the fifth embodiment of the present invention;

FIG. 7 is a partially broken perspective view of a vent assembly having a container in the housing in accordance with the sixth embodiment of the present invention;

FIG. 8 is an exploded perspective view of a one-touch operated vent assembly in accordance with the seventh embodiment of the present invention; and

FIG. 9 is a perspective view, showing a vent assembly of this invention, which is installed at the dashboard of an automobile at a desired position.

### BEST MODE FOR CARRYING OUT THE INVENTION

Reference should now be made to the drawings, in which the same reference numerals are used throughout the different drawings to designate the same or similar components.

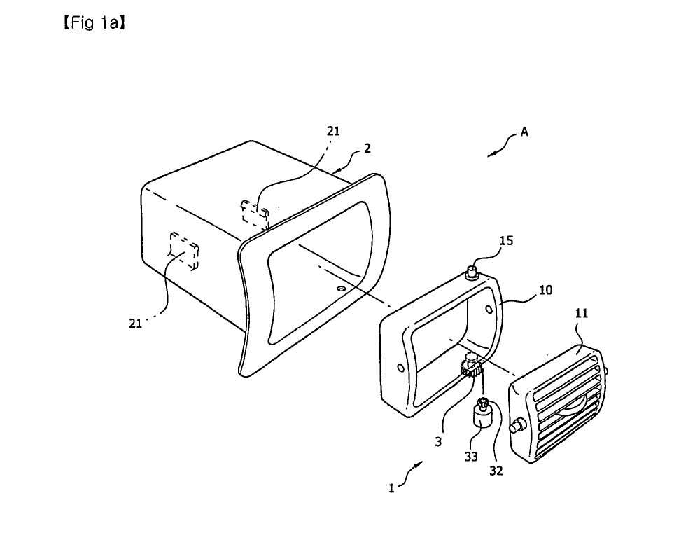

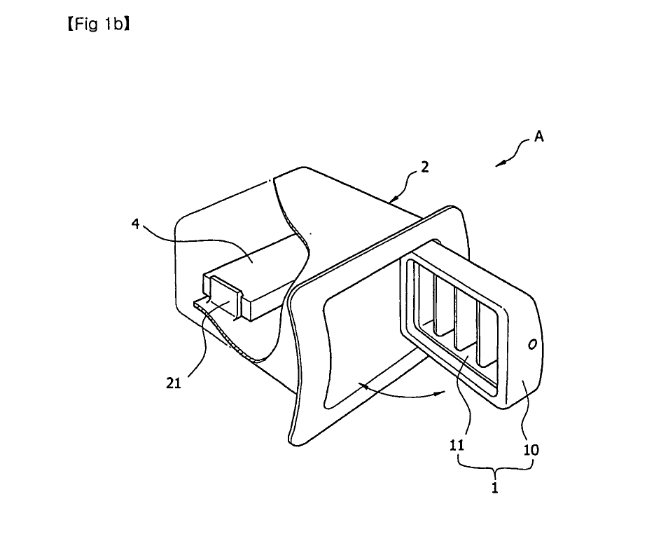

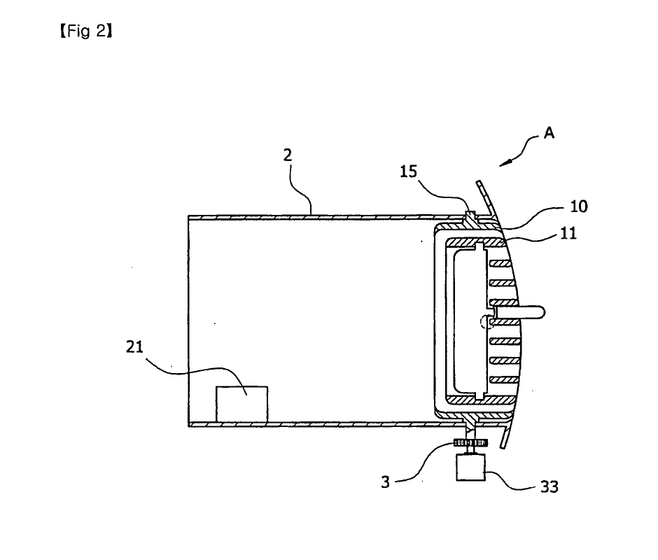

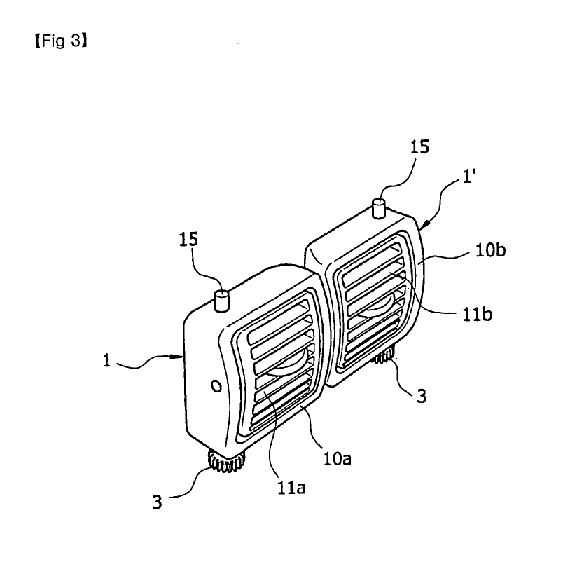

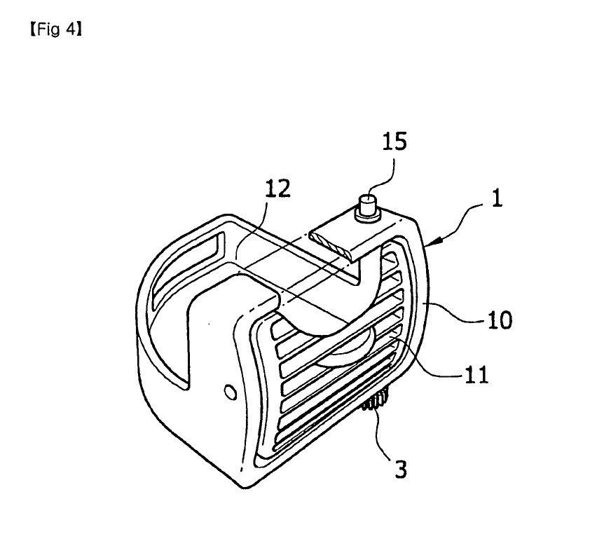

FIG. 1a is an exploded perspective view of a vent assembly for automobiles in accordance with the primary embodiment of this invention. FIG. 1b is a partially broken perspective view, showing an operation of the vent assembly according to the primary embodiment. FIG. 2 is a side sectional view, showing the operation of the vent assembly according to the primary embodiment. FIG. 3 is a perspective view of a vent assembly having two hinged grill units in accordance with the second embodiment of the present invention. FIG. 4 is a perspective view of a vent assembly having a container part at the rear section of a grillwork holder in accordance with the third embodiment of this invention.

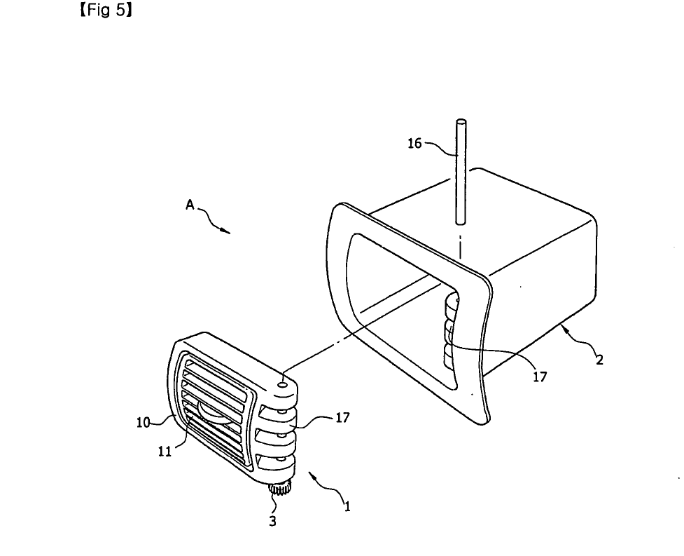

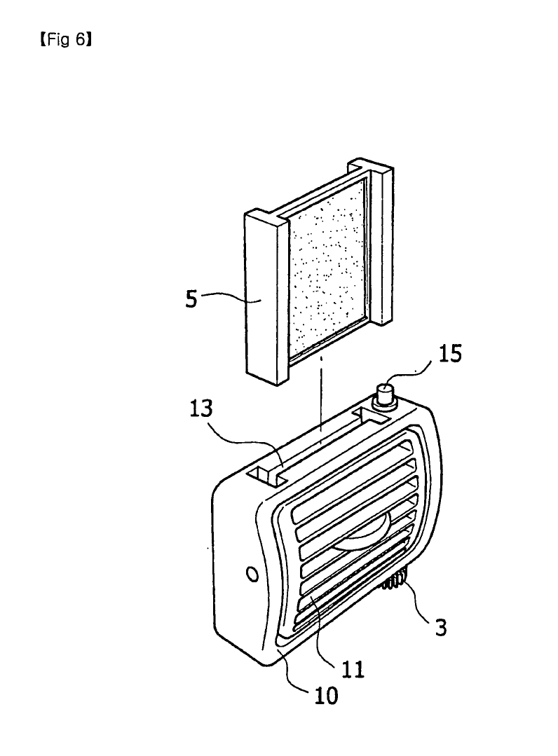

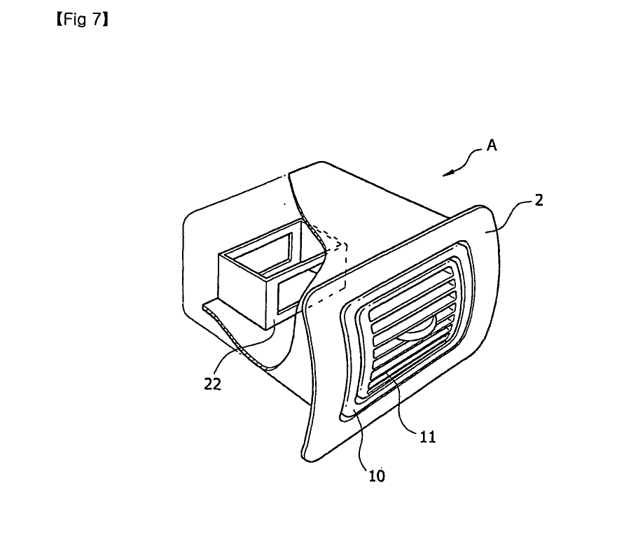

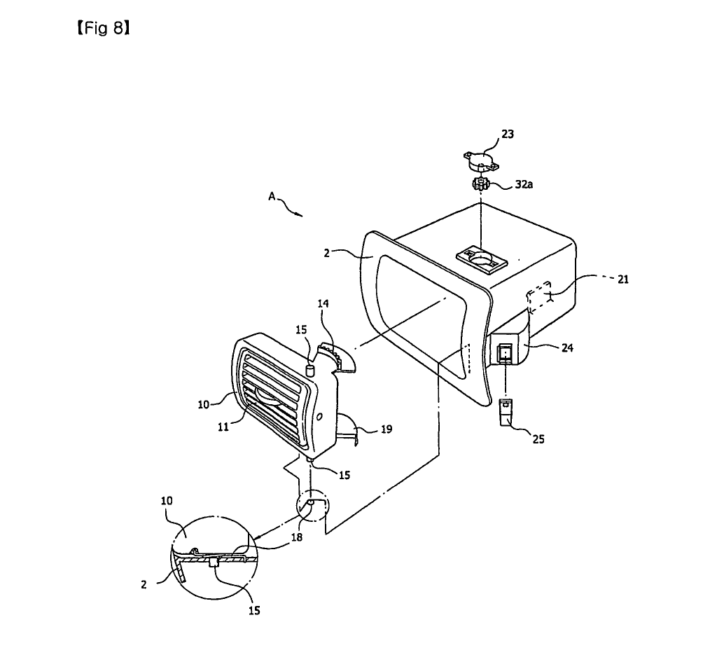

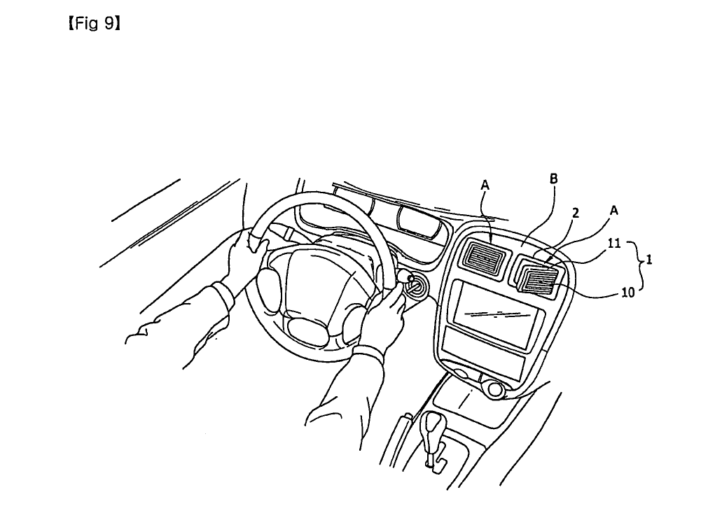

FIG. 5 is an exploded perspective view of a vent assembly having two hinges respectively provided at the grillwork holder and the housing and jointed together by a pin in accordance with the fourth embodiment of this invention. FIG. 6 is a perspective view of a vent assembly having a seating slot for seating an air filter in accordance with the fifth embodiment of this invention. FIG. 7 is a partially broken perspective view of a vent assembly having a container in the housing in accordance with the sixth embodiment of this invention. FIG. 8 is an exploded perspective view of a one-touch operated vent assembly in accordance with the seventh embodiment of this invention. FIG. 9 is a perspective view, showing a vent assembly of this invention, which is installed at the dashboard of an automobile at a desired position. As shown in the drawings, the vent assembly of this invention comprises a grill unit 1, a housing 2, and a drive member 3.

In the vent assembly “A” for automobiles according to the primary embodiment of this invention of FIGS. 1a, 1b and 2, the grill unit 1 consists of a grillwork 11, and a grillwork holder 10 holding the grillwork 11 therein. Two hinge shafts 15 are provided on the holder 10 at upper and lower surfaces for acting as a hinging means for hinging the grill unit 1 to the housing 2. A drive member 3 is provided at a lower portion of the holder 10 at a position vertically aligned with the hinge shafts 15, and engages with a reduction gear 32 of a motor 33 installed in the dashboard “B” of an automobile. The grill unit 1 is rotatably set in the housing 2 by the hinge shafts 15 such that the grill unit 1 is rotated around the shafts 15 relative to the housing 2 by a rotating power of the motor 33 transmitted to the drive member 3 through the reduction gear 32. That is, the grill unit 1 is hinged in the housing 2 by the two hinge shafts 15, acting as the hinging means, and so the grill unit 1 is rotated around the two shafts 15 relative to the housing 2 within a predetermined angular range. The drive member 3, which is provided at the lower end of the lower shaft 15, engages with the reduction gear 32 of the motor 33 installed in the dashboard “B”. Therefore, the grill unit 1 is rotated around the shafts 15 to open or close the housing 2 by the rotating power of the motor 33. In another embodiment of this invention, the hinging means for hinging the grill unit 1 to the housing 2 may comprise two hinges 17, which are respectively provided at the grillwork holder 10 and the housing 2 and jointed together by a pin 16, in place of the hinge shafts 15 as shown in FIG. 5.

In the preferred embodiments, the drive member 3 is a reduction gear, which is provided at the lower portion of the holder 10 and engages with the gear 32 of the motor 33 installed in the dashboard “B”. Therefore, when it is desired to rotate the grill unit 1 to open or close the housing 2, the rotating power of the motor 33 rotates the drive member 3, and so the grill unit 1 is rotated relative to the housing 2 around the hinging means, such as the hinge shafts 15 or the jointed hinges 17. The grill unit 1 thus opens or closes the interior of the housing 2.

The motor 33 is a reversible reduction motor, which is installed in the dashboard “B”. The gear 32 fixed to the output shaft of the motor 33 engages with the reduction gear forming the drive member 3, and so the rotating power of the motor 33 is transmitted to the grill unit 1 and rotates the unit 1 relative to the housing 2 to open or close the interior of the housing 2.

The operational effect of this vent assembly “A” having such a hinged grill unit will be described in detail herein below.

In order to install the vent assembly “A” at the dashboard “B” of an automobile, the housing 2 is primarily fixedly installed in the end of a venting channel formed in the dashboard. The grillwork holder 10 of the grill unit 1 is, thereafter, hinged in the front end of the housing 2 at the hinging means, such as the hinge shafts 15 or the jointed hinges 17. In such a case, it is necessary to bring the reduction gear, forming the drive member 3, into engagement with the gear 32 of the motor 33, thus allowing the drive member 3 to be rotated by the power of the motor 33.

When it is desired to open the housing 2 prior to cleaning the grill unit 1 and the interior of the housing 2, a user operates the reversible reduction motor 33 in a direction by manipulating a control switch (not shown), which is installed in the passenger compartment and connected to the motor 33. In such a case, the rotating power of the motor 33 is transmitted to the grillwork holder 10 of the grill unit 1 through the reduction gear 32 and the drive member 3, thus rotating the grill unit 1 around the hinging means in a direction where the unit 1 opens the housing 2.

In the present invention, the structure for rotating the hinged grill unit 1 relative to the fixed housing 2 may be altered from the above-mentioned structure consisting of the reversible reduction motor 33 and the reduction gear forming the drive member 3, without affecting the functioning of this invention. That is, the vent assembly “A” according to an embodiment of FIG. 8 comprises a fixed housing 2 and a hinged grill unit 1 set in the housing 2, with the grill unit 1 consisting of a grillwork 11, and a grillwork holder 10 holding the grillwork 11 therein, and two hinge shafts 15 provided at the holder 10 for acting as a hinging means for hinging the grill unit 1 to the housing 2 in the same manner as that described for the above-mentioned embodiments. However, different from the above-mentioned embodiments, the vent assembly of FIG. 8 has a torsion coil spring 18, which is fitted over one of the two shafts 15 such that both ends of the torsion spring 18 are respectively stopped by the housing 2 and the holder 10. An arc-shaped rack 14 is provided at an upper portion of the holder 10, while a reduction gear 32a is installed in the housing 2 and engages with the rack 14. A stopper 19 is provided at a lower portion of the holder 10, and a pushbutton-type locking switch 25 is provided in the housing 2 for locking or releasing the stopper 19.

In the vent assembly of FIG. 8, the torsion coil spring 18 is fitted over one of the two shafts 15 of the holder 10, while the arc-shaped rack 14 is integrally formed at the upper portion of the holder 10. The stopper 19 is provided at the lower portion of the holder 10. The rack 14 engages with the reduction gear 32a, which is installed on the internal surface of the housing 2 while being covered by a gear casing 23. The pushbutton-type locking switch 25 is installed in a switch casing 24 provided on the internal surface of the housing 2, and locks or releases the end of the stopper 19 through a one-touch action. When a user manually pushes the closed grill unit 1 once, the stopper 19 is released from the pushbutton-type locking switch 25, thus allowing the grill unit 1 to be rotated in a direction when the housing 2 is opened. When the user manually rotates the open grill unit 1 to its original position in the front end of the housing 2, and slightly pushes the unit 1, the end of stopper 19 is caught by the pushbutton-type locking switch 25, thus maintaining the closed state of the grill unit 1 in the front end of the housing 2. Therefore, this vent assembly allows a user to manually open or close the interior of the housing 2 by rotating the grill unit 1 through a one-touch action as desired.

In the above vent assembly of FIG. 8, the hinging means for hinging the grill unit 1 to the housing 2 may comprise two hinges 17, which are respectively provided at the grillwork holder 10 and the housing 2 and jointed together by a pin 16 in place of the two hinge shafts 15, as shown in FIG. 5.

The vent assembly of this invention thus allows a user to clean the grill unit 1 and the interior of the housing 2 after opening the front end of the housing 2 by rotating the grill unit 1 around its hinging means. In the case of an embodiment, which has a container 22 provided in the housing 2 for containing an aromatic 4 therein as shown in FIG. 7, it is possible to change the existing aromatic 4 with a new one after opening the front end of the housing 2. In the primary embodiment of FIGS. 1a and 1b, two holders 21 in place of the container 22 are provided in the housing 2 for removably holding the aromatic 4 in the housing 2.

In the embodiment of FIG. 4, a container part 12 having a predetermined size is integrally formed at the rear section of the grillwork holder 10 of the grill unit 1, and contains an aromatic 4 therein. In the embodiment of FIG. 6, a seating slot 13 is formed on the upper wall of the grillwork holder 10 of the grill unit 1 so as to removably seat an air filter 5 therein. The vent assembly of this invention thus removes dust from hot or cool air blown into the passenger compartment through the grill unit, and deodorizes the air inside the passenger compartment. Therefore, it is possible for this vent assembly to maintain a fresh and pleasant interior atmosphere of the passenger compartment.

In the present invention, two or more grill units may be hinged in the housing 2 such that the grill units are independently rotated relative to the housing 2 as shown in FIG. 3. In the embodiment of FIG. 3, two grillworks 11a and 11b are respectively set in two holders 10a and 10b to form two grill units 1 and 1′ which are hinged in the fixed housing 2. In this embodiment, one drive member 3 is provided at each of the two holders 10a and 10b. The two drive members 3 of the two grill units 1 and 1′ respectively engage with two motors 33. In addition, one torsion coil spring 18a may be fitted over one of the two shafts 15 of each of the two grill unit 1 and 1′ such that both ends of the torsion spring 18a are respectively stopped by the housing 2 and an associated one of the two holders 10a and 10b. The two grill units 1 and 1′ are independently rotated relative to the housing 2 through a one-touch action, thus opening or closing the interior of the housing 2.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a vent assembly with a hinged grill unit with a hinged grill unit for automobiles. In this vent assembly, the grill unit, used for discharging hot and cold air from an air conditioning apparatus into the passenger compartment of an automobile, is hinged to a fixed housing such that it is rotated relative to the housing through a one-touch action, a torsion spring action, or a motor operation within a predetermined angular range, thereby allowing a user to selectively open the housing when it is desired to clean the grill unit and the interior of the housing. This vent assembly thus allows the user to effectively maintain the vent assembly in a clean state, and blows fresh and clean air into the passenger compartment. In addition, this vent assembly is also provided with a means for containing a desired material, such as an aromatic, with an air filter removably seated in a seating slot of the grill unit, and so the vent assembly blows fresh, clean and scented air into the passenger compartment, and maintains a fresh and pleasant interior atmosphere of the passenger compartment.

1. A vent assembly for automobiles, comprising a housing and a grill unit set in the housing, wherein
said grill unit consists of a grillwork, and a grillwork holder holding said grillwork therein, with both a hinge shaft provided at said holder for acting as hinging means for hinging the grill unit to the housing, and a drive member provided at a lower portion of the holder at a position vertically aligned with said hinge shaft and engaging with a reduction gear of a motor installed in a dashboard of an automobile, said grill unit being rotatably set in said housing by the hinge shaft such that the grill unit is rotated around the shaft relative to the housing by a power of said motor transmitted to the drive member through the reduction gear.

2. A vent assembly for automobiles, comprising a housing and a grill unit set in the housing, wherein
said grill unit consists of a grillwork, and a grillwork holder holding said grillwork therein, with a hinge shaft provided at said holder for acting as hinging means for hinging the grill unit to the housing, a torsion coil spring fitted over the shaft such that both ends of the torsion spring are respectively stopped by the housing and the holder, an arc-shaped rack provided at an upper portion of said holder, a reduction gear installed in said housing and engaging with said rack, a stopper provided at a lower portion of the holder, and a pushbutton-type locking switch provided in said housing for locking or releasing the stopper.

3. The vent assembly according to claim 1 or 2, wherein two or more grill units are hinged in said housing such that the grill units are independently rotated relative to the housing.

4. The vent assembly according to claim 1 or 2, wherein a container is provided in said housing.

5. The vent assembly according to claim 1 or 2, wherein a container part having a predetermined size is integrally formed at a rear section of said grillwork holder.

6. The vent assembly according to claim 1 or 2, wherein a seating slot is formed on an upper wall of the grillwork holder of said grill unit so as to seat an air filter therein.

7. The vent assembly according to claim 1 or 2, wherein a holder is provided in said housing for removably holding an aromatic in the housing.

8. The vent assembly according to claim 1 or 2, wherein said hinging means for hinging the grill unit to the housing comprises two hinges respectively provided at the grillwork holder and the housing, and jointed together by a pin.
